(19) United States
(12) Patent Application Publication
(10) Pub. No.: US 2014/0118222 A1
(43) Pub. Date: May 1, 2014

(54) PROJECTION OF CONTENT TO EXTERNAL DISPLAY DEVICES

(71) Applicant: CLOUDCAR, INC., Los Altos, CA (US)

(72) Inventors: Peter Barrett, Palo Alto, CA (US); Konstantin Othmer, Los Altos, CA (US); Bruce Leak, Los Altos hills, CA (US)

(73) Assignee: CLOUDCAR, INC., Los Altos, CA (US)

(21) Appl. No.: 13/664,204

(22) Filed: Oct. 30, 2012

(51) Int. Cl. G09G 5/00

(52) U.S. Cl. 345/2.2

(57) ABSTRACT

In an example, a method for projecting content from a mobile device to an external display device is described. The method includes discovering characteristics of the external display device at the mobile device. The method also includes reformatting content at the mobile device according to the discovered characteristics of the external display device. The method also includes transmitting the reformatted content from the mobile device to the external display device for display on the external display device. The external display devices may be vehicular display devices, televisions, projectors, etc. When the external display device is a vehicular display device, the mobile device can be used to display content in the vehicle, thereby enhancing the usefulness of the vehicular display device.

### FIELD

Example embodiments described herein relate to projecting content from a mobile device to an external display device.

### BACKGROUND

Many vehicles coming off production lines today include built-in electronics such as navigation systems, DVD players, or other electronics systems. Such built-in electronics often include software and/or hardware that is already outdated by the time the vehicle is sold to the consumer who will use the vehicle. Vehicles manufactured in recent years typically include color display devices and computing or multimedia devices that display content on the display devices. Although navigation systems in new vehicles are useful, they are expensive and, as noted, are typically outdated by the time that the vehicle is manufactured, sold, and then used for several years.

Many consumers also own smartphones, tablets, or other mobile devices that are commonly replaced once every one to two years. One result of the relatively short lifespan of such mobile devices is that they often provide consumers with the latest, or almost the latest, and most up-to-date software and/or hardware. Such mobile consumer applications can operate a huge variety of apps, can access online content, can often interface with mobile telephone networks, and are highly flexible.

Some functionality provided by mobile devices, such as navigation apps, may compete with the built-in electronics provided in vehicles. Because the software and/or hardware of mobile devices is often newer with better performance than the software and/or hardware of a vehicle, consumers may opt to use the mobile devices while driving to accomplish functionality that might also be provided by the vehicle. Thus, it is common for drivers to use mobile devices to access navigation apps, while passengers frequently use mobile devices to view movies, other multimedia content, and to use various apps. The manipulation by drivers of mobile devices and the act of viewing navigation information and other content on the relatively small screens of mobile devices can be dangerous and sometimes violates local traffic laws. Moreover, this situation results in the high-quality display device of the vehicle getting little or no use in many cases.

Unfortunately, the use of mobile devices while driving can lead to driver distractions and potentially dangerous driving conditions. As a result, there is a trend in the United States and other countries of limiting, by law, the functionality that can be available in built-in electronics systems.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY OF SOME EXAMPLE EMBODIMENTS

Some embodiments described herein generally relate to projecting content from a mobile device to an external display device. The mobile device can thereby be used to display data on external display devices, such as those in vehicles, televisions, projectors, etc. This enhances the usefulness of external display devices, particularly those that are found in vehicles. Because mobile devices are typically able to access a large amount and variety of content and can be updated with the latest apps and data, vehicle display devices can be used according to embodiments of the invention to access such timely and varied content, in contrast to limited and sometimes outdated content and functionality that has previously been available on vehicle display devices.

In an example embodiment, a method for projecting content from a mobile device to an external display device is described. The method includes discovering characteristics of the external display device at the mobile device. The method also includes reformatting content at the mobile device according to the discovered characteristics of the external display device. The method also includes transmitting the reformatted content from the mobile device to the external display device for display on the external display device.

In another example embodiment, a system for projecting content from a mobile device to an external display device is described. The system may include the mobile device including a processing device and a computer-readable storage medium having computer instructions stored thereon that are executable by the processing device to perform operations. The operations may include discovering characteristics of an external display device. The operations may also include reformatting content according to the discovered characteristics of the external display device. The operations may also include transmitting the reformatted content from the mobile device to the external display device for display on the external display device.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 is a block diagram of an example operating environment including a mobile device and an external display device;

FIG. 2 is a block diagram of a specific embodiment of the operating environment of FIG. 1;

FIG. 3A is a block diagram of an example mobile device and an example external display device such as may be implemented in the operating environments of FIGS. 1-2;

FIG. 3B illustrates an example of how content may be reformatted by the mobile device of FIG. 3A for the external display device of FIG. 3A;

FIG. 4 is a block diagram of an example intra-vehicle bus interface device such as may be implemented in the operating environments of FIGS. 1-2; and

FIG. 5 is a flowchart of an example method for projecting content from a mobile device to an external display device.

### DETAILED DESCRIPTION OF SOME EXAMPLE EMBODIMENTS

Some embodiments described herein relate to the projection of content from a mobile device, such as a smartphone, to one or more external display devices, such as a television, a projector, or a vehicular display device. The content in some embodiments includes content generated by an app executing on the mobile device, content streamed from a content source through the mobile device to the external display device, or content previously stored on the mobile device. The mobile device may present on a built-in display of the mobile device the same or different content as is projected to the external display device and in the same or a different format, aspect ratio, etc. As used herein, the terms “project,” “projection” and related terms refer to the act of using a mobile device to display or otherwise render or output content on an external device or to provide control of the external device.

Optionally, the mobile device may project content to multiple external display devices. The content projected to each of the multiple external display devices may be the same content, while in other embodiments, the content projected to each of the multiple external display devices may be different content, or any combination thereof.

In an example embodiment, the external display device(s) may be integrated in a vehicle as a vehicular display device. Examples of vehicular display devices include head units, instrument panels, and Digital Versatile Disk (DVD) monitors. In these and other embodiments, an intra-vehicle bus interface (IVBI) device may be communicatively coupled to an intra-vehicle bus of the vehicle, such as a controller area network (CAN) bus of the vehicle. The IVBI device reads data from the intra-vehicle bus and provides it to the mobile device, and/or receives data from the mobile device to write to the intra-vehicle bus.

Data read from the intra-vehicle bus may be used by a content arbiter to determine an operating state of the vehicle and/or a number of people in the vehicle and to selectively limit the projected content and/or the functionality of the mobile device depending on the operating state. The operating state of the vehicle may indicate a relatively high or low likelihood of current or imminent movement of the vehicle. Generally, the content that may be projected to the external display device for display thereon and/or certain functionality of the mobile device may be selectively suppressed based on the operating state of the vehicle.

For example, if the operating state of the vehicle indicates a relatively high likelihood of current or imminent movement, for example, if an automatic transmission of the vehicle is in Drive or Reverse or the tires of the vehicle are currently rotating, or if it is determined that there are no passengers in the vehicle, the content that may be projected to the vehicular display device may be selectively suppressed to avoid distracting a driver of the vehicle from the task of driving, or some functionality of the mobile device, such as some input functionality of the mobile device, may be temporarily and selectively suppressed or disabled. On the other hand, if the operating state of the vehicle indicates a relatively low likelihood of current or imminent movement, for example, if the automatic transmission is in Park or Neutral, the tires of the vehicle are not currently rotating, or an emergency brake is engaged, or if it is determined that there is at least one passenger in the vehicle, the content that may be projected to the vehicular display device may not be suppressed and/or the functionality of the mobile device may not be limited.

Reference will now be made to the drawings to describe various aspects of some example embodiments of the invention. The drawings are diagrammatic and schematic representations of such example embodiments, and are not limiting of the present invention, nor are they necessarily drawn to scale.

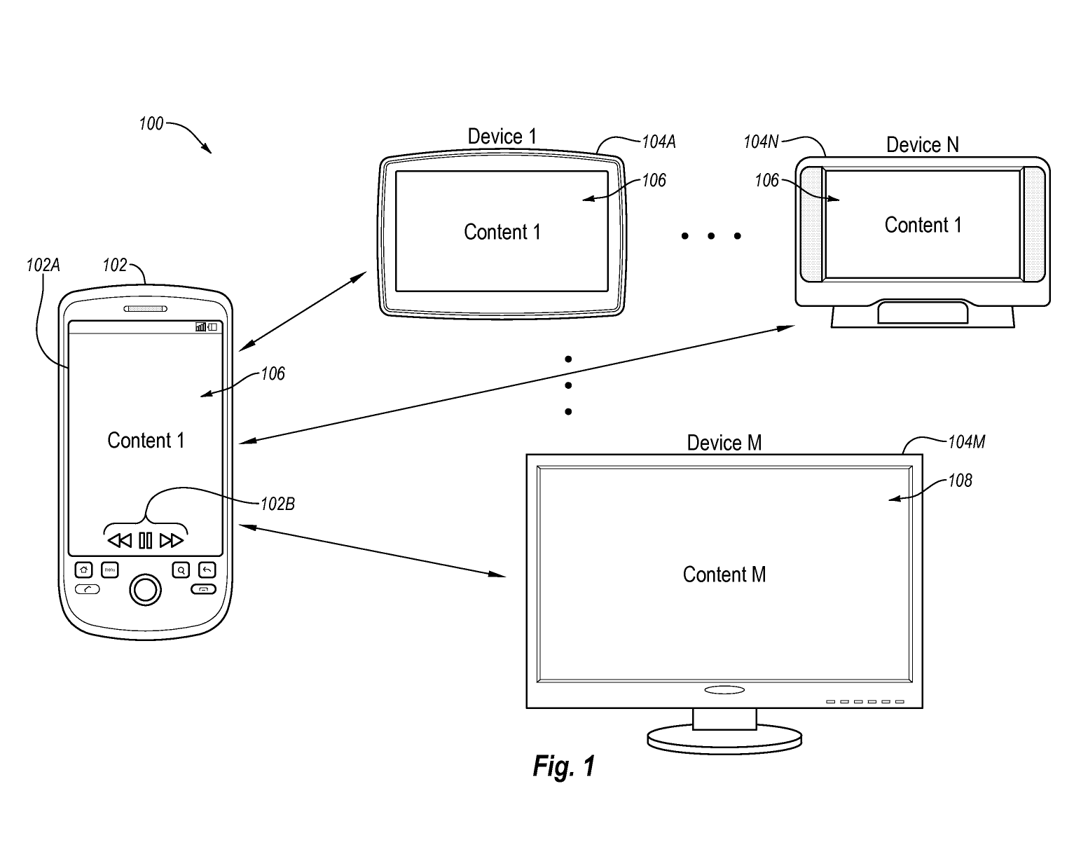

FIG. 1 is a block diagram of an example operating environment 100 including a mobile device 102 and one or more external display devices 104A, 104N and 104M (hereinafter generically referred to as “device 104” or “devices 104”). Although three devices 104 are illustrated in FIG. 1, more generally the environment 100 may include as few as one device 104 or any number of devices that the user might want to employ.

The mobile device 102 may be virtually any communication-enabled mobile device including, but not limited to, a portable media device, a personal digital assistant (PDA), a smartphone, a tablet computer, a laptop computer, or other communication-enabled mobile device. According to some embodiments, a device may be communication-enabled if it includes a corresponding communication interface such as, but not limited to, an IEEE 802.11 interface, a Bluetooth interface, a Universal Mobile Telecommunications System (UMTS) interface or other mobile cellular interface.

In the example operating environment of FIG. 1, the mobile device 102 is configured to project content generated at or received by the mobile device 102 onto one, some, or all of the devices 104. For example, the mobile device 102 may be configured to project first content 106 onto both of the devices 104A, 104N and different, second content 108 onto the device 104M. Optionally, the mobile device 102 may display on a built-in display 102A of the mobile device 102 the same content as is projected to one or more of the devices 104, such as the first content 106 in the example of FIG. 1.

The content projected to the devices 104 is typically described herein as graphical content, such as video files, graphical user interfaces (GUIs), photographs, documents, slides or presentations, and/or other content that can be graphically displayed by the device 104 to which the content is projected. More generally, the content projected to the device 104 by the mobile device 102 can include any type of content that is capable of being rendered in an audible and/or visible format and may include, but is not limited to, audio files, video files, GUIs, photographs, documents, slides or presentations, or other content.

Prior to projecting content onto any of the devices 104, the mobile device 102 may discover characteristics of the corresponding one of the devices 104. The mobile device 102 may, in some cases, reformat the content according to the discovered characteristics prior to transmission to the corresponding one of the devices 104 so that the reformatted content is suitable for display on (or other rendition by) the corresponding one of the devices 104. Alternately, the content may already be in a format suitable for display on the corresponding one of the devices 104 when received at or generated by the mobile device 102, in which case, the mobile device 102 transmits the content to the corresponding one of the devices 104 with reformatting it.

The content projected by the mobile device 102 may be derived from any of a variety of sources. For example, the content may include content stored on the mobile device 102, such as audio files, video files, or other media files stored on the mobile device 102. Alternately or additionally, the content may be streamed from an external content source through the mobile device 102 to the devices 104. Alternately or additionally, the content may be generated by an application executing on the mobile device 102. The foregoing examples are not intended to be limiting and merely identify a few example sources from which content projected onto the devices 104 may be derived.

Each of the devices 104 is generally configured to receive content from the mobile device 102 and display or otherwise render the content. Accordingly, each of the devices 104 may include virtually any device with a display element (or other output device) that can be configured to display (or otherwise render) the content projected onto the device 104 by the mobile device 102. For example, each of the devices 104 may include, but is not limited to, a television, a projector, another mobile device with a built-in monitor, a computer with a built-in or externally connected monitor, or a vehicular display device such as an instrument panel of a vehicle, a head unit of a vehicle, or a DVD monitor of the vehicle, or the like or any combination thereof.

Each of the devices 104 may have characteristics that are the same as or different than corresponding characteristics of the other devices 104. Alternately or additionally, the characteristics of the devices 104 may be the same as or different than corresponding characteristics of the built-in display 102A of the mobile device 102. Examples of the characteristics that each device 104 may have include its pixel size, its aspect ratio, or its H.264 profile.

In some embodiments, the mobile device 102 projects content onto a given one of the devices 104 while touchscreen controls or other user interface elements are displayed primarily or solely on the mobile device. For example, FIG. 1 illustrates that the mobile device 102 displays content navigation touchscreen controls 102B together with the first content 106 on its built-in display 102A, while the devices 104A, 104N display the first content 106 without any touchscreen controls. Accordingly, the mobile device 102 may project content onto a television while maintaining the touchscreen controls on the mobile device 102 so that the mobile device 102 can be used in a manner analogous to a television/video media remote control to, e.g., navigate the content projected onto the television, adjust the volume, or the like or any combination thereof.

By using the mobile device 102 as the content source for the devices 104, processing may be primarily performed by the mobile device 102, which may often include relatively newer software and/or hardware as a result of a shorter lifecycle often associated with mobile devices 102 as compared to some external display devices and the ability to access apps on the mobile device. Moreover, the mobile device 102 can essentially provide network connectivity for the devices 104 without requiring a data plan subscription for the devices 104 separate from a data plan subscription of the mobile device 102. The mobile device 102 can be customized by a user to include one or more desired apps, media, contacts, or other customization, which can be carried over to the devices 104 without separately customizing the devices 104.

When the device 104 is a projector, embodiments described herein can enable users to display slides, presentations, photographs, documents, video, or substantially any other content using the projector. This can provide significant benefits and convenience, thereby eliminating the need to connect a computer to the projector or to carry a portable storage medium (e.g., flash drive) when giving a presentation using a projector. Instead, the user's mobile device, which often can connect to the Internet, can be used to deliver a presentation using a projector.

In another example embodiment or application thereof, one or more devices 104 can be remote with respect to the mobile device 102. In this example, the user can control the display of data on the display device associated with a remote device 104. In this embodiment, communication of the content (e.g., the first content 106) is performed using the principles disclosed herein, while communicating over the Internet or a network that provides access to the remote devices.

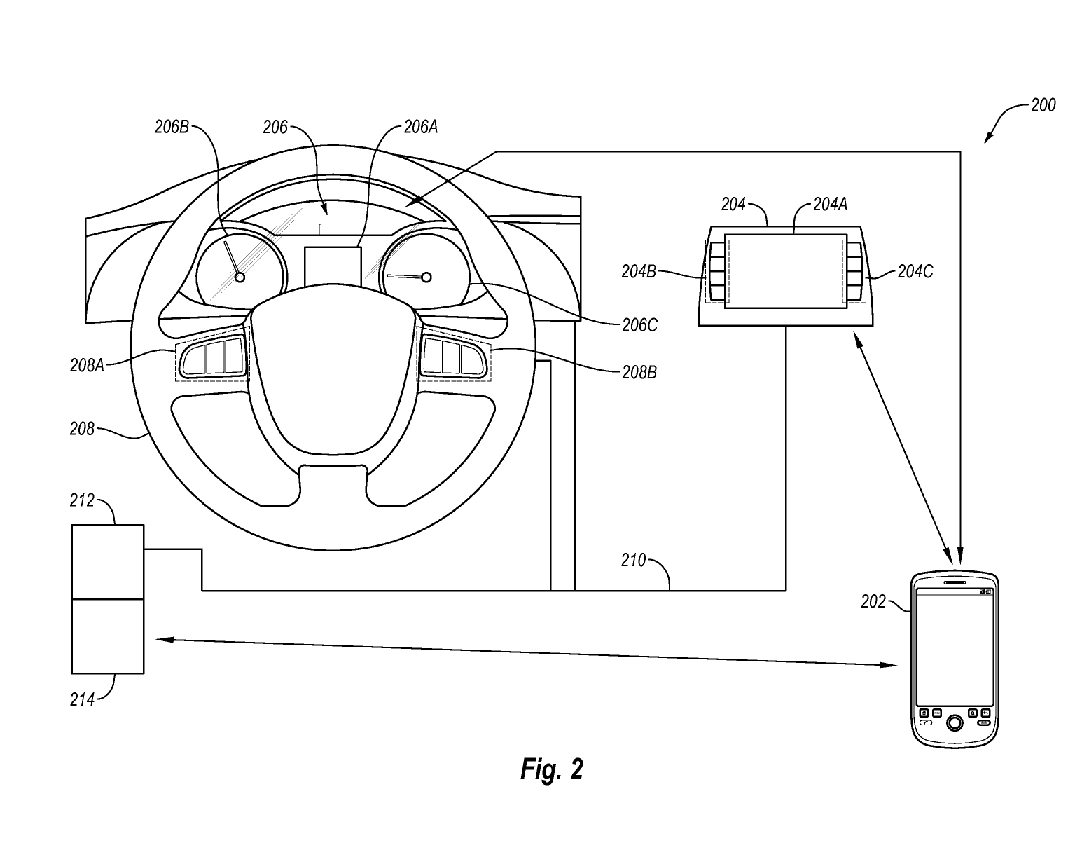

FIG. 2 is a block diagram of a specific embodiment of the operating environment of FIG. 1, referred to herein as environment 200. The environment 200 of FIG. 2 may be located within the interior of a vehicle. The environment 200 includes a mobile device 202 that may generally correspond to the mobile device 102 of Figure, and one or more vehicular display devices 204, 206 that may generally correspond to the devices 104 of FIG. 1. More particularly, the vehicular display devices 204, 206 include a head unit 204 and an instrument panel 206 in the illustrated embodiment. The vehicular display devices 204 and 206 are generally vehicular display devices that can be found in new and used vehicles. The principles and operation of the embodiments of the invention described herein can be adapted for use with existing vehicular display devices and generally do not require the cooperation of the vehicle manufacturer. In some cases, the existing vehicular display devices 204, 206 can be equipped or retrofitted with a wireless interface or other communication device as further described herein to facilitate communication with mobile device 202. In other cases, the vehicular display devices 204, 206 included in new vehicles are adapted by the manufacturer to facilitate the communication.

The head unit 204 includes a display 204A configured to display content such as one or more of maps, navigation instructions, video content from an integrated DVD player, radio or other music information, weather or traffic information, etc. For example, the display 204A may be associated with an existing built-in electronics system that has certain functionality, which is often limited or outdated in the absence of the systems described herein. The head unit 204 additionally includes an input interface, which may include any input device configured to receive user input effective to operate the head unit 204 and potentially other aspects of the vehicle in which the head unit 204 is installed. For example, the input interface of the head unit 204 may include one or more buttons 204B, 204C and/or the display 204A itself when implemented as a touchscreen display. In some embodiments, when the mobile device 202 is projecting content to the head unit 204, user input provided via the input interface of the head unit 204 is used to control operation of the mobile phone 202.

The instrument panel 206 includes at least one display area 206A in which content may be displayed. Accordingly, the mobile device 202 may project content to the instrument panel 206 for display in all or a portion of the display area 206A. Alternately or additionally, the instrument panel 206 may further include one or more fixed instruments 206B, 206C. For example, the fixed instruments 206B, 206C may include a speedometer, a fuel gauge, a temperature gauge, an RPM gauge, or the like or any combination thereof. Although not shown, in some embodiments, the instrument panel 206 may include an input interface such as has been described with respect to the head unit 204.

The environment 200 may further include a steering wheel 208 of the vehicle. In some embodiments, the steering wheel 208 includes an input interface such as has been described above with respect to the head unit 204. The input interface of the steering wheel 208 may include one or more buttons 208A, 208B. In some embodiments, the buttons 208A, 208B are used for one or more of speaker volume control, channel selection, track selection, or for other functionality.

In some embodiments, the environment 200 further includes an intra-vehicle bus 210 to which the head unit 204, the instrument panel 206 and/or the steering wheel 208 are communicatively coupled. The intra-vehicle bus 210 may be configured to allow microcontrollers such as may be implemented in each of the head unit 204, the instrument panel 206 and the steering wheel 208, to communicate with each other. The intra-vehicle bus may include, but is not limited to, a controller area network (CAN) bus.

An access node 212 may be provided to allow access to the intra-vehicle bus 210. For example, an IVBI device 214 may be communicatively coupled to the access node 212 to read data from and/or write data to the intra-vehicle bus 210. In an example embodiment, the access node 212 may include an on-board diagnostics (OBD) connector compliant with a particular OBD interface, such as the OBD-I, OBD-1.5, or OBD-II interfaces.

In some embodiments, user input entered via the buttons 208A, 208B of the steering wheel 208 and/or entered via other input interfaces of the vehicle, which other input interfaces are not part of an external display device to which the mobile device 202 is projecting content, may be used to control operation of the mobile device 202. For example, data representing the user input may be communicated on the intra-vehicle bus 210, read by the IVBI device 214, and communicated by the IVBI device 214 to the mobile device 202 either wirelessly or via a hardwired connection.

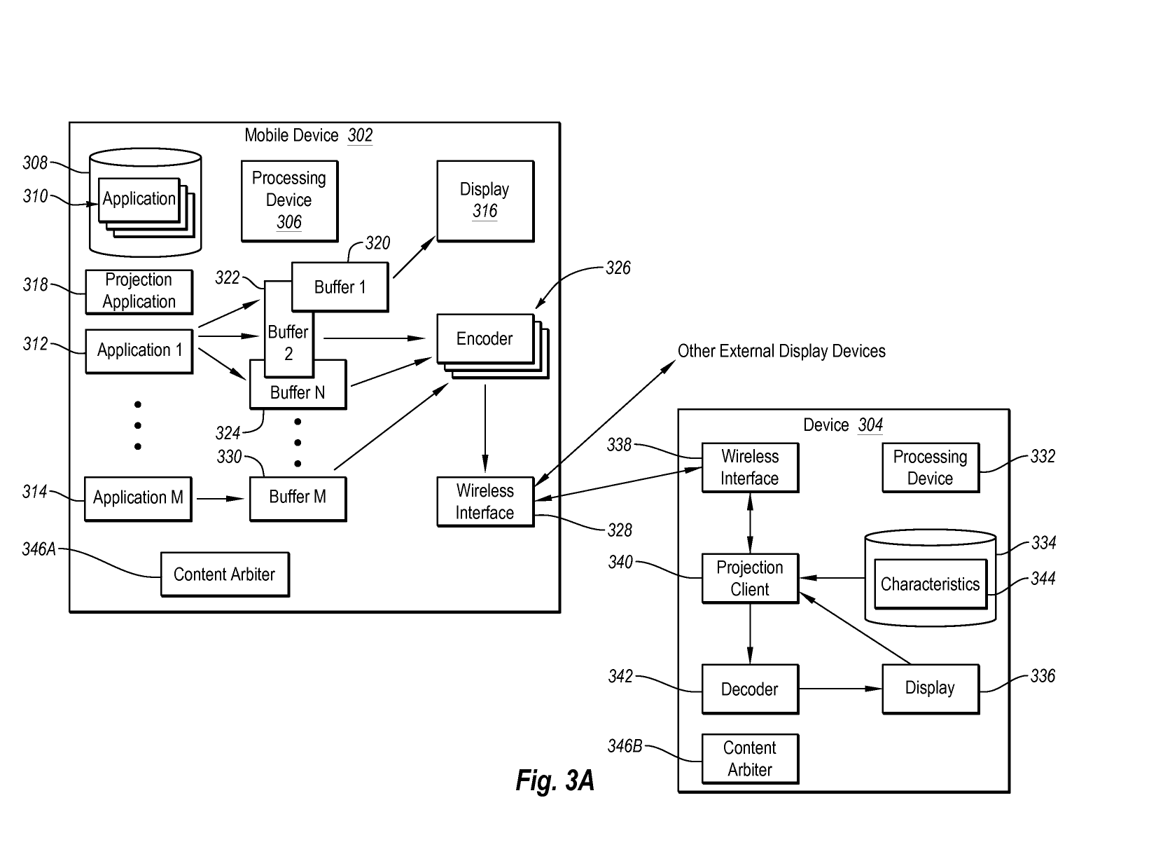

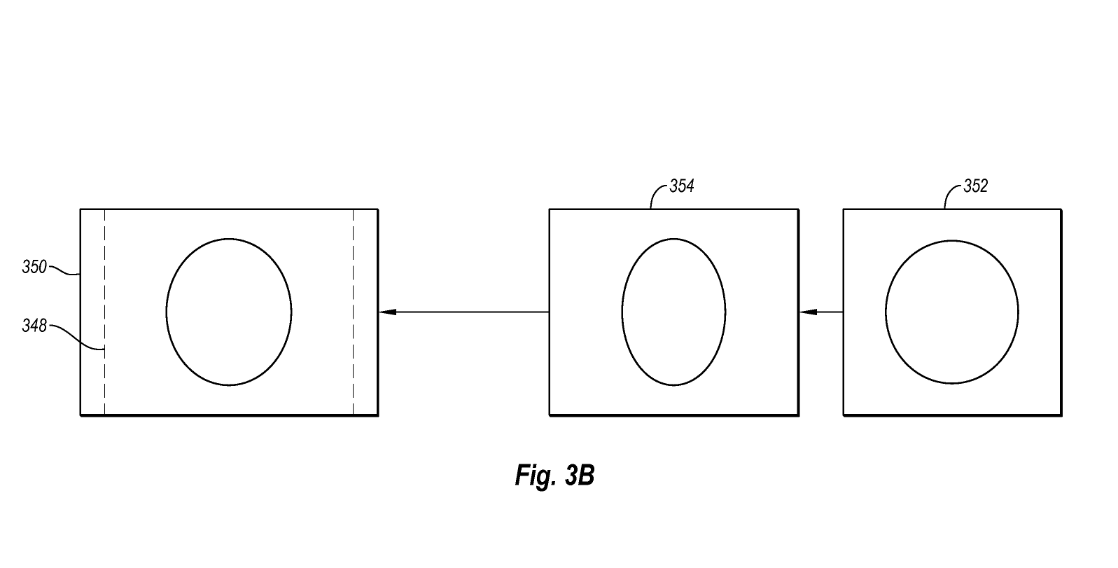

FIG. 3A is a block diagram of an example mobile device 302 and an example external display device 304 (hereinafter device 304) such as may be implemented in the operating environments of FIGS. 1-2. For example, the mobile device 302 may correspond to any of the mobile devices 102, 202 of FIGS. 1-2, while the device 304 may correspond to any of the devices 104, 204, 206 of FIGS. 1-2.

In this example embodiment, the mobile device 302 includes a processing device 306 and a computer-readable storage medium 308 (hereinafter “storage medium 308”). The processing device 306 is configured to execute computer instructions stored on the storage medium 308 to perform one or more of the operations described herein, such as operations associated with projecting content from the mobile device 302 to the device 304.

The storage medium 308 may include, but is not limited to, a magnetic disk, a flexible disk, a hard-disk, an optical disk such as a compact disk (CD) or DVD, and a solid state drive (SSD) to name a few. Another example of a computer-readable storage medium that may be included in the mobile device 302 may include a system memory (not shown). Various non-limiting examples of system memory include volatile memory such as random access memory (RAM) or non-volatile memory such as read only memory (ROM), flash memory, or the like or any combination thereof.

One or more applications 310 may be stored in the storage medium 308 and executed by the processing device 306 to become corresponding instantiated applications 312, 314 that generate or render content locally or receive content from an external content source. Generally, the instantiated applications 312, 314 may be configured to output content to a built-in display 316 of the mobile device 302.

Additionally, a projection application 318 including computer instructions stored on the storage medium 308 or elsewhere may be executed by the processing device 306 to perform operations associated with projecting content to one or more external display devices, such as the device 304. For example, execution of the projection application 318 may cause the mobile device 302 to, among other things, discover characteristics of the device 304, reformat content at the mobile device 302 according to the discovered characteristics, and transmit the reformatted content to the device 304 for display on the device 304.

Each of the applications 312, 314 may draw content to one or more buffers, each buffer corresponding to a different display to which the content will be provided. As an example, where content from the application 312 is mirrored on the mobile device 302 and at least one other external display device, the application 312 may draw its content to at least a first buffer 320 and a second buffer 322, up to potentially an nth buffer 324. Each buffer 320, 322, 324 may define an aspect ratio corresponding to a display device to which the respective buffered content may be provided.

For example, whereas the buffered content in the first buffer 320 may be provided to the built-in display 316 of the mobile device 302, the first buffer 320 may define an aspect ratio corresponding to the built-in display 316. Alternately or additionally, the buffered content may be formatted in the first buffer 320 according to a pixel size of the built-in display 316 and/or may be provided to the built-in display 316 with a resolution corresponding to a resolution of the built-in display 316.

As another example, the buffered content in the second and nth buffers 322, 324 may be projected to corresponding external display devices, each having an aspect ratio that may be defined by the respective buffer 322, 324 so that the buffered content may have the correct aspect ratio when projected to the corresponding external display device. Alternately or additionally, the buffered content may be formatted in the respective buffer 322, 324 according to a pixel size of the corresponding external display device. Encoders 326 may be provided in the mobile device 302, each configured to encode buffered content according to the resolution of the external display device to which the content is being projected. Thus, certain characteristics, such as aspect ratio, pixel size, resolution, or the like, may be reformatted as compared to content created for the built-in display 316 to suit corresponding characteristics of the external display device to which the buffered content in the buffer 322, 324 is projected.

Encoded content may then be transmitted to a corresponding external display device by a wireless interface 328. Alternately or additionally, other data, including data representing user input, commands and/or other data, may be received from and/or transmitted to corresponding external display devices by the wireless interface 328. The wireless interface 328 may include a Bluetooth wireless interface, a WiFi (or more generally, an IEEE 802.11) wireless interface, or other suitable wireless interface.

Similar to the application 312, the application 314 may draw content it generates into a buffer 330 (or buffers) defining an aspect ratio of a display to which the buffered content will be provided, and/or the buffered content may be formatted according to a pixel size of the corresponding display. Further, the buffered content in the buffer 330 may be encoded by a corresponding one of the encoders 326 and either provided directly to the built-in display 316, or transmitted to the corresponding external display device by the wireless interface 328.

Although not illustrated, the mobile device 302 may receive content from an external content source instead of or in addition to generating or rendering the content locally. To the extent the received content is already suitable for display at a corresponding external display device, the received content may be provided to the corresponding external display device without reformatting the content. For example, if the aspect ratio, pixel size, resolution, or other characteristics of the received content match characteristics of the corresponding external display device, the received content may not be drawn into a buffer to alter its aspect ratio, pixel size, or resolution as described herein.

The device 304 may generally include a processing device 332, a computer-readable storage medium 334 (hereinafter “storage medium 334”), a display 336, a wireless interface 338, a projection client 340, and a decoder 342. The processing device 332 may be configured to execute computer instructions stored on the storage medium 334 to perform one or more of the operations described herein such as operations associated with receiving content projected from the mobile device 302.

The storage medium 334 may be implemented as any of the types of storage media described above with respect to the storage medium 308. The storage medium 334 may include stored thereon one or more characteristics 344 of the device 304, or more particularly, one or more characteristics 344 of the display 336. The characteristics 344 may include, but are not limited to, pixel size of the display 336, an aspect ratio of the display 336, one or more supported H.264 profiles of the display 336, or the like or any combination thereof.

The display 336 may be configured to display content projected from the mobile device 302. In some embodiments, the display 336 includes a touchscreen display and may thus serve as an input interface of the device 304 for receiving user input to control the mobile device 302. Alternately or additionally, an input interface separate from the display 336 may be provided as part of the device 304.

The wireless interface 338 may be configured to facilitate communication with the mobile device 302, including the reception of projected content, and/or the transmission/reception of data representing user data, commands, and/or other data. The wireless interface 338 may include a Bluetooth wireless interface, a WiFi (or more generally, an IEEE 802.11) wireless interface, or other suitable wireless interface.

The projection client 340 may configure the device 304 to receive content projected from the mobile device 302 for display on the display 336. In some embodiments, the projection application 318 establishes a client-server relationship with the projection client 340 on the device 304. In some embodiments, software-upgradeable legacy external display devices have the projection client 340 installed thereon to configure the legacy external display devices to receive and display projected content from a mobile device, such as the mobile device 302.

As illustrated in FIG. 3A, the projection client 340 may receive, via the wireless interface 338, content projected from the mobile device 302, which content may be provided to the decoder 342 to be decoded prior to display on the display 336. Alternately or additionally, the projection client 340 may receive data representing user input from the display 336, which data may be provided via the wireless interface 338 to the mobile device 302 to control operation of the mobile device 302. The projection client 340 may be adapted to receive content from other sources, including content encoded using other formats and protocols. In this regard, projection client 340 can be used as a universal receiver to enable mobile device 302 to receive content from a variety of sources. One example is that projection client can be adapted for use with AirPlay, which is a proprietary protocol of Apple Computers. Substantially any other protocol or data format can be used in connection with this embodiment. Moreover, projection client 340 can be external to device 304 as opposed to being integrated therein or installed thereto as illustrated in FIG. 3A.

Prior to the mobile device 302 projecting content to the device 304, the projection application 318 and the projection client 340 may engage in an announcement protocol in which the device 304 sends the mobile device 302 an announcement message describing the characteristics 344 of the device 304. Optionally, the announcement message may include an unencrypted simple service discovery protocol (SSDP) announcement message.

FIG. 3B illustrates an example of how content may be reformatted by the mobile device 302 for the device 304 of FIG. 3A. In the illustrated embodiment, the decoder 342 of the device 304 has a native resolution of 480×720 and the display 336 of the device 304 has a native resolution of 480×800. The native resolution of the decoder 342 and the native resolution of the display 336 are conceptually illustrated in FIG. 3B at 348 and 350, respectively. Because of the mismatch between the native resolution 348 of the decoder 342 and the native resolution 350 of the display 336, a different aspect ratio has to be pushed into the decoder 342 to represent the whole display 336.

The resolutions 348, 350 of the decoder 342 and/or the display 336 may be communicated by the device 304 to the mobile device 302 during the announcement protocol, for example. The mobile device 302 has content 352 that is going to be projected to the device 304. In these and other embodiments, the mobile device 302 does not reformat the content 352 to match the resolution 350 of the display 336. Instead, the mobile device 302 may use Open Graphics Library (OpenGL) with a transformation to render the content 352 into a corresponding one of the buffers 322, 324 at the native resolution 348 of the decoder 342 to generate reformatted content 354. The reformatted content 354 may then be sent to the device 304 at the native resolution 348 of the decoder 342 where it can be stretched by the decoder 342 to fit the native resolution 350 of the display 336.

FIG. 3B illustrates one example of a mapping process done at the encoding step which may enable the data to be transmitted from the mobile device 302 to the device 304 with little latency. A reverse mapping process may be performed when back channel data, e.g., data representing user input received from an input device of the device 304 and used to control the mobile device 302, is received from the device 304.

Returning to FIG. 3A, other communications between the mobile device 302 and the device 304 may be encrypted. In an example embodiment, a command control protocol is executed by the mobile device 302 and the device 304 after the mobile device 302 discovers the characteristics of the device 304. The command control protocol may include exchanging keys over a secure link such as Hypertext Transfer Protocol Secure (HTTPS). The exchanged keys may be used to encrypt subsequent communications between the mobile device 302 and the device 304. For instance, the content projected to the device 304 may be encrypted, and/or data representing user input transmitted to the mobile device 302 may be encrypted.

Alternately or additionally, the projection application 318 may coordinate error recovery with the device 304, or more particularly with the projection client 340, of content projected to the device 304. Alternately or additionally, error recovery may be coordinated or performed by the encoders 326. Coordinating error recovery with the device 304 may include one or more of: implementing a time-based retry method with the device 304; retransmitting to the device 304 data gaps in frames transmitted to the device 304 in response to identification of the data gaps by the device 304; performing forward error correction (FEC) on the content prior to transmitting it to the device 304, or instructing the device 304 to disregard a reference frame identified by the device 304 as missing.

The projection application 318 and/or the encoders 326 may optionally implement one or more optimization algorithms when projecting content to external display devices. For instance, adaptive bitrate streaming, increasing/decreasing compression, adaptive resolution, or other protocols may be implemented to optimize the transmission of content to the external display devices.

The projection of content from the mobile device 302 to the device 304 may occur over a low latency link. For example, the link may have a latency of about 50 milliseconds (ms) or less. The error recovery and/or optimization algorithms described above may reduce the latency of the link between the mobile device 302 and the device 304. In some embodiments, the link includes a direct point-to-point connection between the mobile device 302 and the device 304 with predictability and no other data traffic. Compared to sending data over the Internet, for example, there is relatively little jitter associated with transmission of data packets over the link described herein. As a result, the decoder 342 of the device 304 need not have significant buffering which can reduce the latency of the link.

Embodiments described herein can implement other techniques for reducing latency of the link between the mobile device 302 and the device 304. For example, rather than coding an entire frame at a time and then sending it, each frame can be encoded by the mobile device 302 in slices, which effectively allows the encode time to overlap with the send. By doing so, the latency between when the end of a given frame is output by the encoder 326 of the mobile device 302 and the sending thereof can be significantly reduced compared to encoding an entire frame at a time. In some embodiments, the latency may be about a third or a quarter of what it would otherwise be when entire frames are encoded at a time.

As another example, error concealment techniques may be applied where intracoded blocks are sent in a rolling pattern. Each slice row may be sent as an intracoded block in which the intracoded blocks are P frames with macroblocks designated intra. In these and other embodiments, errors that appear on, e.g., the display 336, may only last for a relatively small maximum number of frames, such as six frames maximum in some embodiments.

As another example, if the projection client 340 on the device 304 realizes that a slice is missing, it does not send a re-try to the projection application 318 of the mobile device 302. Rather, the projection client 340 sends a notification back to the projection application 318 indicating that the slice is missing and that the projection application 318 should not send any intercoded blocks that refer to the data from the missing slice for prediction. Instead, the projection application 318 may next send to the projection client 340 an intracoded block that does not refer to the data from the missing slice.

In some embodiments, such as embodiments in which the device 304 is integrated in a vehicle, a content arbiter 346A, 346B (hereinafter generically referred to as “content arbiter 346”) may be provided on one or both of the mobile device 302 and/or the device 304. The content arbiter 346 may communicate with an IVBI device, such as the IVBI device 214 of FIG. 2, to determine an operating state of the vehicle, a number of people in the vehicle, and/or any other information which tends to indicate a relatively high or low likelihood of current or imminent movement of the vehicle. The content arbiter 346 may selectively suppress the content that may be displayed by the display 336 and/or other functionality of the mobile device 302 depending on the operating state of the vehicle.

For example, the content arbiter 346A may selectively suppress the content that is projected from the mobile device 304 to the device 304 depending on the operating state of the vehicle. As another example, the content arbiter 346B may selectively suppress content that is displayed or otherwise rendered by the device 304 depending on the operating state of the vehicle.

Alternately or additionally, the content arbiter 346A may selectively suppress or disable certain functionality of the mobile device 302 depending on the operating state of the vehicle. Examples of the functionality of the mobile device 302 that may be selectively suppressed may include touch input functionality to prevent a driver of the vehicle from operating the mobile device 302 via touch input while driving.

In some embodiments, the external display device to which a mobile device projects content may include a legacy television or other external display device configured to communicate according to a Digital Living Network Alliance (DLNA) protocol. In these and other embodiments, the mobile device may be configured to mimic a DLNA server to communicate with the external display device and project content from the mobile device to the external display device.

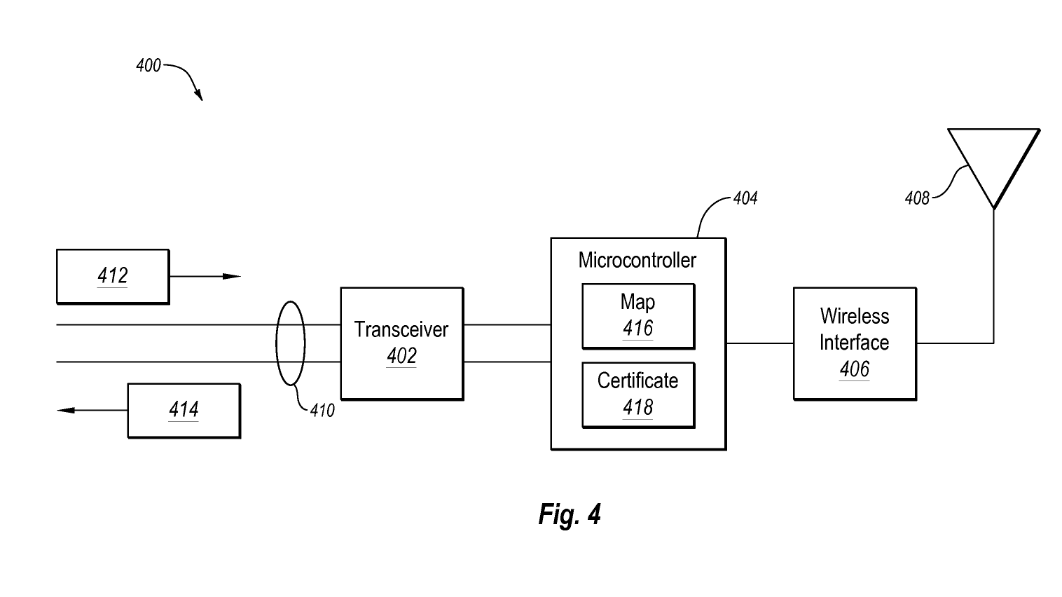

FIG. 4 is a block diagram of an example IVBI device 400 such as may be implemented in the operating environments of FIGS. 1-2. For example, the IVBI device 400 may correspond to the IVBI device 214 of FIG. 2. In the illustrated embodiment, the IVBI device 400 includes a transceiver 402, a microcontroller 404, a wireless interface 406, and an antenna 408.

The IVBI device 400 is communicatively coupled to an intra-vehicle bus 410, which may include differential transmission lines of a CAN bus or other suitable intra-vehicle bus.

The microcontroller 404 may be configured to read messages 412 propagating on the intra-vehicle bus 410 via the transceiver 402. Alternately or additionally, the microcontroller 404 may be configured to write messages 414 onto the intra-vehicle bus 410 via the transceiver 402. The microcontroller 404 may be further configured to wirelessly communicate with a mobile device, such as any of the mobile devices 102, 202, 302, via the wireless interface 406 and antenna 408. The wireless interface 406 may include a Bluetooth wireless interface, a WiFi (or more generally, an IEEE 802.11) wireless interface, or other suitable wireless interface.

The microcontroller 404 may include one or more maps 416 and one or more certificates 418. The map 416 may be configured to translate some or all of the different messages 412 that may propagate on the intra-vehicle bus 410 to a generic form that can be presented in an application programming interface (API) to mobile devices that communicate with the IVBI device 400. Because message codes used by different makes and models of vehicles may be different, each map 416 may be specific to a given make and model of vehicle. Alternately, some maps 416 may be used for two or more different makes and/or models of vehicles where at least some message codes used by the two or more different makes and/or models of vehicles are the same. The map 416 may also be used to translate messages 414 written onto the intra-vehicle bus 410 from a generic form to a form understandable by the vehicle according to its specific make and model.

The certificate 418 or other credentials may be used by the microcontroller 404 to authenticate those devices that attempt to communicatively couple to the intra-vehicle bus 410 via the IVBI device 400. Different certificates may be used for different levels of access to the intra-vehicle bus 410 and the level of access granted to a given device attempting to communicate with the IVBI device 400 may depend on the certificate possessed by the given device. Thus, certificates 418 may be used to ensure that only authorized mobile devices can communicate with the intra-vehicle bus 410, and authorization of mobile devices may be limited to those devices that are programmed to limit use of the communication with the intra-vehicle bus 410 to one or more predetermined uses to avoid any malicious use thereof.

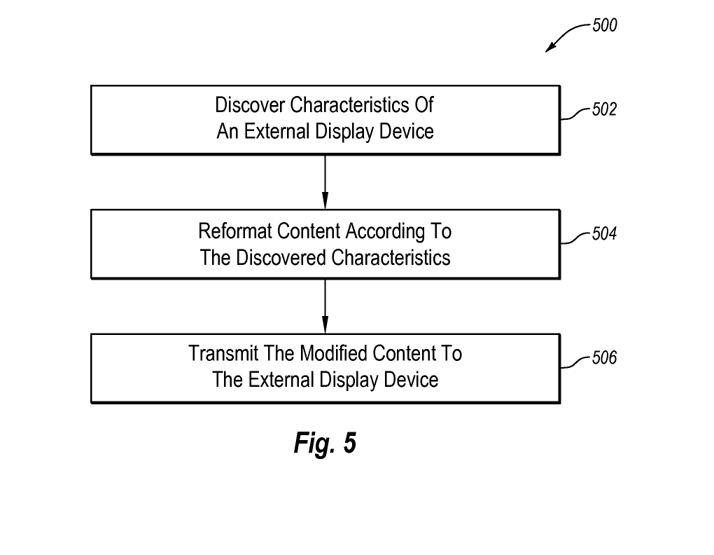

FIG. 5 is a flowchart of an example method 500 for projecting content from a mobile device to an external display device. The method 500 and/or variations thereof may be implemented, in whole or in part, by a mobile device, such as any of the mobile devices 102, 202, 302 of FIGS. 1-3A. Alternately or additionally, the method 500 and/or variations thereof may be implemented, in whole or in part, by a processing device executing computer instructions stored on a computer-readable storage medium. Although illustrated as discrete blocks, various blocks may be divided into additional blocks, combined into fewer blocks, or eliminated, depending on the desired implementation.

The method 500 may begin in block 502 in which characteristics of an external display device are discovered by a mobile device. In some embodiments, discovering characteristics of the external display device may include receiving, from the external display device, an SSDP announcement message describing the characteristics of the external display device. As previously mentioned, the discovered characteristics of the external display device may include one or more of a pixel size, aspect ratio, or H.264 profile of the external display device.

In block 504, content at the mobile device may be reformatted according to the discovered characteristics of the external display device. Reformatting the content according to the discovered characteristics may include at least one of: formatting the content according to a pixel size included in the discovered characteristics; drawing the content into a buffer defining an aspect ratio included in the discovered characteristics; or encoding the content with a resolution included in the discovered characteristics.

In block 506, the reformatted content may be transmitted from the mobile device to the external display device for display on the external display device.

One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

For example, the method 500 may additionally include coordinating error recovery with the external display device as described above.

Alternately or additionally, the discovered characteristics of the external display device may include both a first supported H.264 profile and a different second supported H.264 profile of the external display device. Thus, reformatting content according to the discovered characteristics in block 504 may include encoding the content with a first resolution corresponding to the first supported H.264 profile or with a second resolution corresponding to the second support H.264 profile. In these and other embodiments, the method 500 may further include applying an adaptive resolution algorithm to selectively switch between encoding the content with the first resolution or the second resolution to accommodate a variable encoding bandwidth. For example, the adaptive resolution algorithm may switch to the H.264 profile with the lower resolution to relieve pressure on the encoding channel when relatively less bandwidth is available.

The external display device may include a first external display device, the content may include first content, and the reformatted content may include first reformatted content. The method 500 may further include discovering characteristics of a second external display device by the mobile device. The first content may be reformatted at the mobile device according to the discovered characteristics of the second external display device to generate second reformatted content. The second reformatted content may be transmitted from the mobile device to the second external display device for display on the second external display device while also transmitting the first reformatted content to the first external display device.

Alternately or additionally, the method 500 may further include discovering characteristics of a second external display device by the mobile device. Second content may be reformatted at the mobile device according to the discovered characteristics of the second external display device to generate second reformatted content. The second reformatted content may be transmitted from the mobile device to the second external display device for display on the second external display device while also transmitting the first reformatted content to the first external display device.

Alternately or additionally, the method 500 may further include receiving second content from an external content source in a format suitable for devices having at least some of the discovered characteristics of the external display device. The second content may be transmitted to the external display device without reformatting the second content for display on the external display device.

In some embodiments, the external display device may be integrated with a vehicle. Data representing user input entered via the vehicle may be received by the mobile device. The mobile device may be controlled according to the user input entered via the vehicle. For example, the user input may be entered by a user via an input interface associated with the external display device. As another example, the user input may be entered by the user via an input interface located on a steering wheel or other location of the vehicle. Alternately or additionally, the method 500 may further include selectively suppressing content that may be displayed on the external display device based on an operating state of the vehicle.

The embodiments described herein may include the use of a special purpose or general-purpose computer including various computer hardware or software modules, as discussed in greater detail below.

Embodiments within the scope of the present invention also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above should also be included within the scope of computer-readable media.

Computer-executable instructions comprise, for example, instructions and data which cause a general purpose computer, special purpose computer, or special purpose processing device to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used herein, the term “module” or “component” can refer to software objects or routines that execute on the computing system. The different components, modules, engines, and services described herein may be implemented as objects or processes that execute on the computing system (e.g., as separate threads). While the system and methods described herein are preferably implemented in software, implementations in hardware or a combination of software and hardware are also possible and contemplated. In this description, a “computing entity” may be any computing system as previously defined herein, or any module or combination of modulates running on a computing system.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method for projecting content from a mobile device to an external display device, the method comprising:
discovering characteristics of the external display device by the mobile device;
reformatting content at the mobile device according to the discovered characteristics of the external display device; and
transmitting the reformatted content from the mobile device to the external display device for display on the external display device.

2. The method of claim 1, wherein discovering characteristics of the external display device comprises receiving, from the external display device, a simple service discovery protocol (SSDP) announcement message describing the characteristics of the external display device.

3. The method of claim 1, wherein the discovered characteristics of the external display device include at least one of pixel size, aspect ratio, or an H.264 profile.

4. The method of claim 1, wherein the discovered characteristics of the external display device include a first supported H.264 profile of the external display device and a different second supported H.264 profile of the external display device.

5. The method of claim 4, wherein reformatting content at the mobile device includes encoding the content with a first resolution corresponding to the first supported H.264 profile or with a second resolution corresponding to the second supported H.264 profile, the method further comprising applying an adaptive resolution algorithm to selectively switch between encoding the content with the first resolution or with the second resolution to accommodate a variable encoding bandwidth.

6. The method of claim 1, wherein the external display device comprises a television, a projector, an instrument panel of a vehicle, a head unit of the vehicle, or a DVD monitor of the vehicle.

7. The method of claim 1, wherein the external display device comprises a first external display device, the content comprises first content and the reformatted content comprises first reformatted content, the method further comprising:
discovering characteristics of a second external display device by the mobile device;
reformatting the first content at the mobile device according to the discovered characteristics of the second external display device to generate second reformatted content; and
transmitting the second reformatted content from the mobile device to the second external display device for display on the second external display device while also transmitting the first reformatted content to the first external display device.

8. The method of claim 1, wherein the external display device comprises a first external display device, the content comprises first content and the reformatted content comprises first reformatted content, the method further comprising:
discovering characteristics of a second external display device by the mobile device;
reformatting second content at the mobile device according to the discovered characteristics of the second external display device to generate second reformatted content; and
transmitting the second reformatted content from the mobile device to the second external display device for display on the second external display device while also transmitting the first reformatted content to the first external display device.

9. The method of claim 1, wherein the content comprises first content and the reformatted content comprises first reformatted content, the method further comprising:
receiving second content from an external content source in a format suitable for devices having at least some of the discovered characteristics of the external display device; and
transmitting the second content to the external display device without reformatting the second content for display on the external display device.

10. The method of claim 1, wherein reformatting the content includes at least one of:
formatting the content according to a pixel size included in the discovered characteristics;
drawing the content into a buffer defining an aspect ratio included in the discovered characteristics; or
encoding the content with a resolution included in the discovered characteristics.

11. The method of claim 1, further comprising coordinating error recovery with the external display device.

12. The method of claim 11, wherein coordinating error recovery with the external display device includes at least one of:
implementing a time-based retry method with the external display device;
retransmitting to the external display device data gaps in frames transmitted to the external display device in response to identification of the data gaps by the external display device;
performing forward error correction (FEC) on the reformatted content prior to transmitting the reformatted content to the external display device; or
instructing the external display device to disregard a reference frame identified by the external device as missing.

13. The method of claim 1, wherein the external display device is integrated with a vehicle, the method further comprising:
receiving data representing user input entered via the vehicle; and
controlling the mobile device according to the user input entered via the vehicle.

14. The method of claim 1, wherein:
the user input is entered by a user via an input interface associated with the external display device; or
the user input is entered by the user via an input interface located on a steering wheel of the vehicle.

15. The method of claim 1, wherein the external display is integrated with a vehicle, the method further comprising selectively suppressing content that may be displayed on the external display device based on an operating state of the vehicle.

16. The method of claim 1, further comprising:
receiving data representing user input entered via an input interface of the external display device; and
controlling the mobile device according to the user input.

17. A system for projecting content from a mobile device to an external display device, the system comprising:
the mobile device including a processing device and a computer-readable storage medium having computer instructions stored thereon that are executable by the processing device to perform operations comprising:
discovering characteristics of an external display device;
reformatting content according to the discovered characteristics of the external display device; and
transmitting the reformatted content from the mobile device to the external display device for display on the external display device.

18. The system of claim 17, wherein the external display is integrated with a vehicle including an intra-vehicle bus to which the external display is communicatively coupled, the system further comprising an intra-vehicle bus interface device configured to communicatively couple the mobile device to the intra-vehicle bus.

19. The system of claim 18, wherein:
the external display device includes a first input interface;
the vehicle includes a second input interface different than the first input interface and communicatively coupled to the intra-vehicle bus;
the operations further include at least one of:
receiving data representing user input entered via the first input interface directly from the external display device; or
receiving data representing user input entered via the second input interface indirectly via the intra-vehicle bus interface device; and
the operations further include controlling the mobile device according to the user input.

20. The system of claim 17, further comprising a projection client installed on the external display device and configured to support bidirectional communication between the mobile device and the external display device.

21. The system of claim 17, wherein:
the external display device comprises a legacy television configured to communicate according to a Digital Living Network Alliance (DLNA) protocol; and
the operations further comprise mimicking a DLNA server to communicate with the external display device.

22. A method for projecting content from a mobile device to an external display device, the method comprising:
discovering characteristics of the external display device by the mobile device, including a pixel size, aspect ratio, and H.264 profile of the external display device;
reformatting content at the mobile device according to the discovered characteristics of the external display device;
transmitting the reformatted content from the mobile device to the external display device for display on the external display device;
receiving data representing user input entered via an input interface of the external display device; and
controlling the mobile device according to the user input.
